(19) United States
(12) Patent Application Publication
(10) Pub. No.: US 2021/0357847 A1
(43) Pub. Date: Nov. 18, 2021

(54) METHOD AND APPARATUS FOR AUTOMATICALLY GENERATING WORKER POOL BASED ON FUNCTIONAL ELEMENT AND DIFFICULTY LEVEL OF CROWDSOURCING-BASED PROJECT

(71) Applicant: CROWDWORKS INC., Seoul (KR)

(72) Inventors: Min Woo Park, Gyeonggi-do (KR); Ju Yeong Kim, Seoul (KR)

(21) Appl. No.: 17/389,251

(22) Filed: Jul. 29, 2021

Related U.S. Application Data
(63) Continuation of application No. PCT/KR2021/005968, filed on May 12, 2021.

(30) Foreign Application Priority Data
May 12, 2020 (KR) 10-2020-0056236

(51) Int. Cl. G06Q 10/06

(52) U.S. Cl. CPC G06Q 10/063112; G06Q 10/06315; G06Q 10/063114

(57) ABSTRACT

Provided are an active learning method and apparatus using consistency-based normalization in which an uncertainty measurement technique and a normalization loss are combined, the active learning method using the consistency-based normalization including: performing data augmentation on data learned in every cycle of active learning; selecting data to be labeled on the basis of a loss of the consistency-based normalization by using the data on which the data augmentation is performed; and training a classifier to set a generalization error boundary on the basis of the selected data.

### TECHNICAL FIELD

The present disclosure relates to a method and apparatus for automatically generating a worker pool based on a functional element and a difficulty level of a crowdsourcing-based project.

### BACKGROUND ART

Recently, more and more companies have been collecting and processing large amounts of data based on crowdsourcing that engages the general public in some processes of company activities. In other words, a company opens one project and allows the general public, i.e., workers, to participate in the corresponding project to collect needed information via the results of work completed by the workers.

Here, the company assigns an inspector the results of work completed by a worker and requests the inspector to perform inspection work, to collect more reliable information.

In detail, when one project is opened, a plurality of tasks are assigned to each of a plurality of workers. Each worker performs a plurality of assigned tasks and provides work results of the tasks. Each of a plurality of inspectors is assigned a plurality of inspection tasks for the work results, and each inspector performs the assigned inspection tasks.

In order to select workers to participate in a project scheduled to be opened, there is a need for processes of setting participation conditions and selecting, one by one, workers who meet the participation conditions.

However, the process of setting the participation conditions and the process of selecting, one by one, the workers who meet the participation conditions are costly and time consuming. Therefore, there is a need for a method of automatically determining workers to participate in a project scheduled to be opened by considering characteristics between a previously completed project and the project scheduled to be opened.

### DESCRIPTION OF EMBODIMENTS

### Technical Problem

Provided is a method of automatically generating a worker pool based on a functional element and a difficulty level of a crowdsourcing-based project, capable of clustering a plurality of projects by considering functional elements and difficulty levels of the projects and templating workers who participate in a project belonging to the generated cluster to generate a worker pool, and automatically applying the templated worker pool to a project scheduled to be opened.

The problems to be solved by the present disclosure are not limited to the problems described above, and other problems may be present.

### Solution to Problem

According to an aspect of the present disclosure, a method of automatically generating a worker pool based on a functional element and a difficulty level of a crowdsourcing-based project may include: identifying functional elements of a plurality of completed crowdsourcing-based projects (hereinafter, first projects); evaluating difficulty levels of the plurality of first projects by using work histories of the plurality of first projects; clustering the plurality of first projects into a plurality of clusters, on the basis of the functional elements and the difficulty levels of the plurality of first projects; templating and generating, for each of the clusters, a worker pool (hereinafter, a templated worker pool) including a plurality of workers who participate in one or more first projects belonging to each of the clusters; identifying a functional element of a crowdsourcing-based project (hereinafter, a second project) scheduled to be opened; evaluating a predicted difficulty level of the second project by using pilot tasks of the second project; selecting any one of the plurality of clusters, on the basis of the functional element and the predicted difficulty level of the second project; applying the templated worker pool of the selected cluster as a worker pool of the second project; opening the second project and assigning a plurality of tasks of the second project to a plurality of workers of the templated worker pool to request performance of the tasks; and receiving a plurality of work results from the plurality of workers of the templated worker pool, wherein the functional element is determined on the basis of a work tool for performing a project, the work tool is a tool provided by the project and used by workers to perform tasks requested by the project, the method further includes: after the second project is completed, evaluating an actual difficulty level of the second project by using a work history of the second project; and determining whether or not to assign the second project to the selected cluster by comparing the predicted difficulty level of the second project with the actual difficulty level, the method further includes, when an additional worker pool is applied as the worker pool of the second project in addition to the templated worker pool of the selected cluster, and the second project is determined to be assigned to the selected cluster, updating the templated worker pool of the selected cluster by using the worker pool of the second project, and, the method further includes, when the second project is determined not to be assigned to the selected cluster, not updating the templated worker pool of the selected cluster by using the worker pool of the second project.

The difficulty level may be evaluated on the basis of at least one of a point in time of submission of work results of a certain percentage of all tasks of a project, a rejection rate of initial work results, and a rejection rate of rework results.

The clustering the plurality of first projects into the plurality of clusters on the basis of the functional elements and the difficulty levels of the plurality of first projects may include: primarily clustering the plurality of first projects into a plurality of clusters, on the basis of identity of the functional elements of the plurality of first projects; and secondarily clustering, for each of the clusters according to the result of the primary clustering, a plurality of first projects belonging to each of the clusters into a plurality of clusters, on the basis of the difficulty levels of the plurality of first projects.

The evaluating the predicted difficulty level of the second project by using the pilot tasks may include using a certain percentage of all tasks of the second project as the pilot tasks. The percentage may be determined according to reliability of the evaluation of the predicted difficulty level.

The method may further include: assigning the plurality of work results to a plurality of inspectors to request performance of inspection; and receiving, from the plurality of inspectors, a plurality of inspection results for the plurality of work results as inspection passes or rejections, wherein the work history of the second project is recorded by using the plurality of inspection results.

According to another aspect of the present disclosure, an apparatus for automatically generating a worker pool based on a functional element and a difficulty level of a crowdsourcing-based project may include: a processor; and a memory storing a program for automatically determining a worker pool based on the functional element and the difficulty level of the project, wherein the processor executes the program to identify functional elements of a plurality of completed crowdsourcing-based projects (hereinafter, first projects), evaluate difficulty levels of the plurality of first projects by using work histories of the plurality of first projects, cluster the plurality of first projects into a plurality of clusters, on the basis of the functional elements and the difficulty levels of the plurality of first projects, template and generate, for each of the clusters, a worker pool (hereinafter, a templated worker pool) including a plurality of workers who participate in one or more first projects belonging to each of the clusters, identify a functional element of a crowdsourcing-based project (hereinafter, a second project) scheduled to be opened, evaluate a predicted difficulty level of the second project by using pilot tasks of the second project, select any one of the plurality of clusters, on the basis of the functional element and the predicted difficulty level of the second project, apply the templated worker pool of the selected cluster as a worker pool of the second project, open the second project and assign a plurality of tasks of the second project to a plurality of workers of the templated worker pool to request performance of the tasks, and receive a plurality of work results from the plurality of workers of the templated worker pool, wherein the functional element is determined on the basis of a work tool for performing a project, the work tool is a tool provided by the project and used by workers to perform tasks requested by the project, and, after the second project is completed, the processor evaluates an actual difficulty level of the second project by using a work history of the second project, determines whether or not to assign the second project to the selected cluster, by comparing the predicted difficulty level of the second project with the actual difficulty level, when an additional worker pool is applied as the worker pool of the second project in addition to the templated worker pool of the selected cluster, determines to assign the second project to the selected cluster and updates the templated worker pool of the selected cluster by using the worker pool of the second project, and, when determining not to assign the second project to the selected cluster, does not update the templated worker pool of the selected cluster by using the worker pool of the second project.

According to another aspect of the present disclosure, a computer program may be stored in a computer-readable recording medium to be combined with a computer to execute a method of automatically generating a worker pool based on a functional element and a difficulty level of a crowdsourcing-based project.

Other detailed matters of the present disclosure are included in the description and drawings.

### Advantageous Effects of Disclosure

According to the present disclosure described above, the time and cost of selecting a worker for a new project scheduled to be opened may be significantly reduced.

In particular, unlike an existing method of manually selecting a worker, similar projects may be clustered by considering functional elements and difficulty levels of projects together, and a plurality of workers belonging to the cluster may be templated and configured as a worker pool, thereby automatically applying the worker pool to a new project scheduled to be opened.

The effects of the present disclosure are not limited to the effects mentioned above, and unmentioned other effects may be clearly understood by one of ordinary skill in the art from the following description.

### BRIEF DESCRIPTION OF DRAWINGS

FIG. 1 is a conceptual diagram of a crowdsourcing service according to an embodiment of the present disclosure.

FIG. 2 is a flowchart illustrating a process of a crowdsourcing-based project, according to an embodiment of the present disclosure.

FIG. 3 is a flowchart of a method of automatically generating a worker pool based on a functional element and a difficulty level of a crowdsourcing-based project, according to an embodiment of the present disclosure.

FIG. 4 is a view illustrating an example of clustering a plurality of first projects into a plurality of clusters.

FIG. 5 is a view illustrating an example of primarily and secondarily clustering a plurality of first projects into a plurality of clusters.

FIG. 6 is a flowchart illustrating a process of updating a templated worker pool of a cluster.

FIG. 7 is a view illustrating the contents of updating a templated worker pool.

FIG. 8 is a block diagram illustrating an apparatus for automatically generating a worker pool, according to an embodiment of the present disclosure.

### MODE OF DISCLOSURE

Advantages and features of the disclosure, and methods of achieving thereof will become apparent with reference to the embodiments described below in detail in conjunction with the accompanying drawings. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art, and the disclosure is merely defined by the scope of claims.

The terminology used herein is for the purpose of describing the embodiments and is not intended to limit the disclosure. As used herein, the singular forms are intended to include the plural forms as well, unless the context clearly indicates otherwise. The terms “comprises” and/or “comprising” when used in this specification do not preclude the presence or addition of one or more other elements in addition to stated elements. Like reference numerals refer to like elements throughout. As used herein, the term “and/or” includes any and all combinations of one or more of the associated listed items. Although the terms “first,” “second,” etc. may be used herein to describe various elements or components, these elements or components should not be limited by these terms. These terms are only used to distinguish one element or component from another element or component. Thus, a first element or component discussed below may be termed a second element or component without departing from the scope of example embodiments.

Unless otherwise defined, all terms (including technical and scientific terms) used herein have the same meanings as commonly understood by one of ordinary skill in the art to which example embodiments belong. Terms, such as those defined in commonly used dictionaries, will not be interpreted in an idealized or overly formal sense unless expressly so defined herein.

Hereinafter, embodiments of the present disclosure will be described in detail with reference to the accompanying drawings.

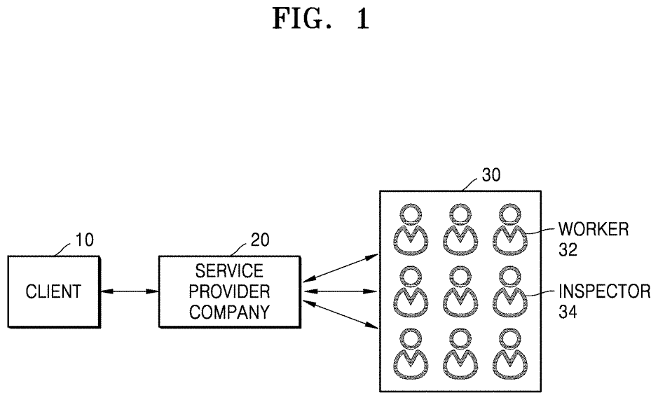

FIG. 1 is a conceptual diagram of a crowdsourcing service according to an embodiment.

Referring to FIG. 1, a crowdsourcing service is performed by constituting a client 10, a service provider company 20, and the public 30.

The client 10 refers to a company or individual that commissions a crowdsourcing-based project (hereinafter, a project).

The client 10 commissions the project, for the collection of source data for the generation of artificial intelligence learning data, data annotation, or the like. Data generated via the project may be used as learning data for any machine learning such as supervised learning, unsupervised learning, or reinforcement learning. The collection of the source data refers to the collection of raw data such as the collection of recorded voice and the collection of photos. The data annotation refers to inputting associated annotation data into source data such as text, photos, and video. For example, the data annotation may include finding an entity in given text, finding a similar sentence, and the like but is not limited thereto. The type of project described above is only an embodiment, and various types of projects may be handled in the disclosure according to the design of a client.

The service provider company 20 refers to a company that provides a crowdsourcing service.

When receiving, from the client 10, a request for a product or service project, the service provider company 20 assigns work on the corresponding project to the public 30 and receives the results of the work from the public 30. Final outputs extracted on the basis of the results of work are provided to the client 10.

Here, the service provider company 20 provides the client 10 and the public 30 with crowdsourcing services via a crowdsourcing platform (hereinafter, a platform). In other words, when the service provider company 20 receives a project request from the client 10, the service provider company 20 opens a project on the platform. When the service provider company 20 receives, from the public 30, the results of the work on the opened project, the service provider company 20 may end the corresponding project on the platform, extract final outputs, and provide the extracted final outputs to the client 10.

The public 30 refers to the general public who participates in the project opened on the platform. Here, the public 30 may participate in the project opened on the platform, via an application, website, or the like provided by the service provider company 20.

The public 30 includes a worker 32 and an inspector 34.

The worker 32 determines to participate in a particular project from among a plurality of projects opened on the platform. The worker 32 performs work such as the collection of source data and data annotation, and transmits the same to the platform.

The inspector 34 determines to participate in a particular project from among the plurality of projects opened on the platform. The inspector 34 performs inspection on the results of work performed by the worker 32. The inspector 34 may perform inspection pass processing or rejection processing as the results of the inspection performance, and may input the reasons for the rejections when performing rejection processing. In the cases of inspection passes, reworks and subsequent reinspection are not needed, and thus, inspection passes mean the same as the completion of inspection.

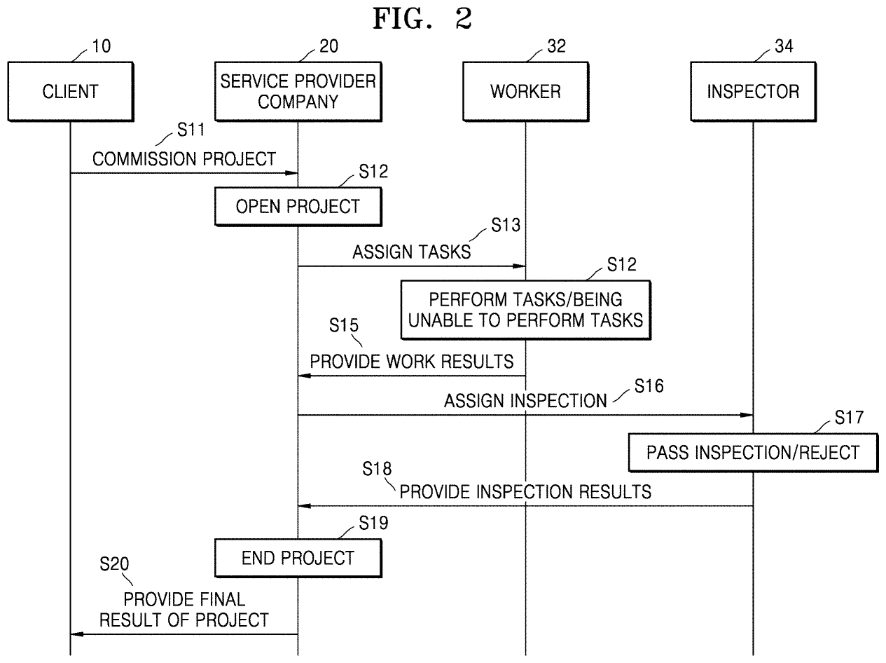

FIG. 2 is a flowchart illustrating a process of a crowdsourcing-based project according to an embodiment.

In operation S11, a client 10 commissions one or more projects to a service provider company 20.

In operation S12, the service provider company 20 opens the commissioned projects on a platform. Here, before opening a project, the service provider company 20 may determine a grade of the project by considering a level of difficulty of the corresponding project and the like. In other words, the service provider company 20 may determine to expose the corresponding project to the public 30 having a certain grade or higher, according to the level of difficulty. Accordingly, the reliability of work results of a project may be improved.

In operation S13, the service provider company 20 assigns tasks to a worker 32 having a corresponding grade or higher, according to the grade of the project, and requests to perform the tasks.

In operation S14, the worker 32 performs the assigned tasks. Here, the worker 32 may not perform a task that may not be performed for some reason and input a reason for not being able to perform the task.

In operation S15, the service provider company 20 receives work results from the worker 32 and, in operation S16, assigns inspection work for the corresponding work results to an inspector 34 and requests inspection.

Similarly, according to an embodiment, only appropriate projects from among all projects that are being performed may be exposed to the inspector 34 according to grades or qualification requirements of the inspector 34 that are set according to the levels of difficulty of the projects.

In operation S17, the inspector 34 performs the assigned inspection. Here, the inspector 34 determines an inspection pass when a task is determined as being appropriately performed and processes the task as a rejection when the task is determined, via inspection work, as being incorrectly performed. When processing the rejection, the inspector 34 inputs a reason for the rejection of the task being determined as being incorrectly performed.

In operation S18, the service provider company 20 receives the results of inspection from the inspector 34.

When the results of inspection are inspection passes, the service provider company 20 uses the corresponding work results as valid data and, on the basis of the valid data, extracts final outputs at the end of the project.

When the results of inspection are rejection processing, the service provider company 20 may internally re-perform inspection, or may re-assign tasks to the worker 32 and request to perform rework. Reinspection by an inspector is needed upon rework.

The service provider company 20 terminates the corresponding project in operation S19 when a project period ends or sufficient valid data is secured, and, on the basis of the secured valid data, calculates the final results and provides the final results to the client 10 in operation S20.

Here, before the project ends, the service provider company 20 evaluates the performance results of the worker 32 and the inspector 34, calculates work cost and inspection cost according to the evaluation, and pays the work cost and inspection cost to the worker 32 and the inspector 34.

FIGS. 1 and 2 simply illustrate the client 10, the service provider company 20, the worker 32, and the inspector 34. However, the client 10, the service provider company 20, the worker 32, and the inspector 34 may refer to computer apparatuses or telecommunication devices such as smartphones, tablets, personal digital assistants (PDAs), laptops, desktops, and servers operated by respective participants.

The service provider company 20 needs to select workers 32 having certain qualifications to assign tasks of a project to the workers 32, and a process of selecting the workers 32 also takes a lot of cost and time.

A method of selecting a project similar to a corresponding project and arranging, in the corresponding project, workers 32 who participate in the similar project may be considered to solve the drawbacks described above.

A functional element needed for performing a project may be a significant element in determining whether or not a corresponding project corresponds to a similar project. For example, in the case of a project such as the collection of photos, the project is performed through a functional element referred to as capturing. When a functional element of a previously performed project include capturing, and a new project to be opened also includes a functional element referred to as capturing, the new project may be determined as a similar project.

However, projects may not be concluded as being similar to each other only with functional elements of the projects. The respective projects may have different difficulty levels, and, even in the case of the above capturing example, difficulty levels of the projects may be significantly different from each other according to types of photos to be collected.

Also, when projects are determined as being similar to each other on the basis of only functional elements of the projects, too many projects may be handled as projects that are similar to one another. In particular, this drawback may be more significant in a simple project including only a simple functional element on a screen in an online work space where the project is performed.

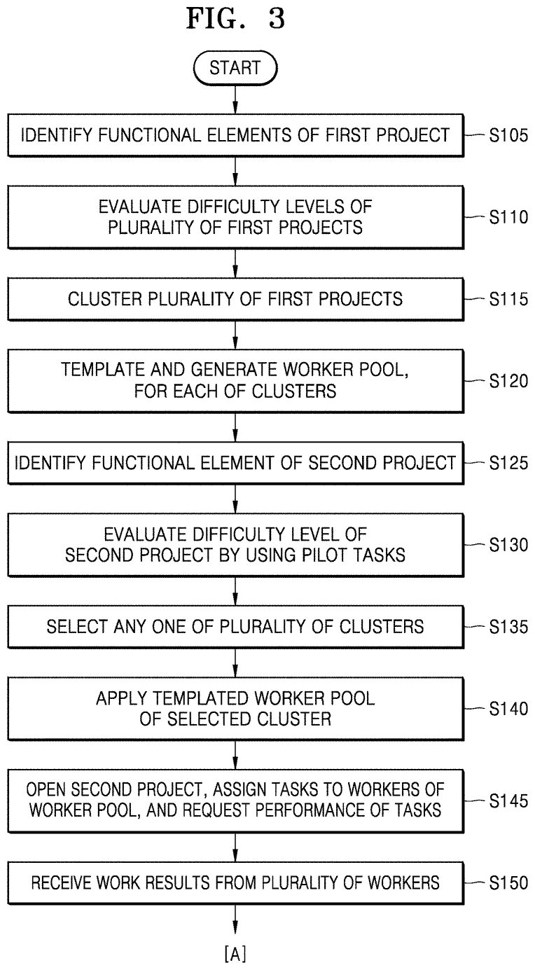

Accordingly, a technology capable of selecting a similar project by further considering a difficulty level of a project together with a functional element of the project and enabling workers 32 who participate in the selected similar project to participate in a corresponding project is needed. Therefore, hereinafter, a method of automatically generating a worker pool based on a functional element and a difficulty level of a crowdsourcing-based project according to an embodiment of the present disclosure will be described with reference to FIGS. 3 through 7.

FIG. 3 is a flowchart of a method of automatically generating a worker pool based on a functional element and a difficulty level of a crowdsourcing-based project, according to an embodiment of the present disclosure.

It may be understood that operations illustrated in FIG. 3 are performed by a platform server (hereinafter, a server) operated by the service provider company 20, but the operations are not limited thereto.

Also, a plurality of workers 32 or a plurality of inspectors 34 perform tasks by using certain terminal apparatuses. The terminal apparatuses of the workers 32 or the inspectors 34 may be computer apparatuses or telecommunication devices such as smartphones, tablets, personal digital assistants (PDAs), laptops, or desktops but not limited thereto.

Referring to FIG. 3, in operation S105, the server identifies functional elements of a plurality of completed crowdsourcing-based projects (hereinafter, referred to as first projects).

Here, the functional elements of the first projects are determined based on a work tool for performing the first projects. Also, the work tool refers to a tool that is provided by the first projects and used by the workers 32 to perform tasks requested by the first projects.

Simple examples of the work tool may include a text input tool, a radio button input tool, an audio cut tool, a tool for drawing work using a mouse, a pen, or other devices, and various types of tools capable of performing element functions by interworking with external devices.

In an embodiment of the present disclosure, a first project refers to a completed project, and a second project refers to a project scheduled to be opened.

In operation S110, the server evaluates difficulty levels of the plurality of first projects by using work histories of the plurality of first projects.

Here, a work history refers to certain log data recorded in relation to each task and a project according to the progress of the project.

In an embodiment, the server opens a first project by setting workers 32 and inspectors 34. Also, as the performance of tasks by the worker 32 is completed, the server assigns a plurality of work results to a plurality of inspectors 34 to request the performance of inspection, and receives, from the plurality of inspectors 34, a plurality of inspection results for the plurality of work results. Here, an inspection result may be an inspection pass or rejection. The server may record the plurality of inspection results as a work history of the first project.

A difficulty level in an embodiment of the present disclosure is used to cluster first projects into a plurality of clusters, and is also used to select, for a second project, any one of the plurality of clusters. The details of evaluating such a difficulty level will be described together in an operation of evaluating a difficulty level of a second project.

In operation S115, the server clusters the plurality of first projects into a plurality of clusters, on the basis of functional elements and difficulty levels of the plurality of first projects. Here, clustering refers to clustering similar projects together.

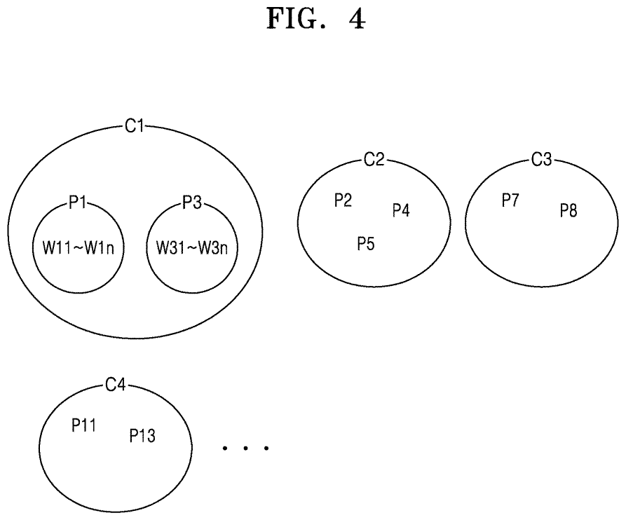

FIG. 4 is a view illustrating an example of clustering a plurality of first projects into a plurality of clusters.

In an embodiment, a plurality of first projects may be clustered into a plurality of first, second, and third clusters, and the like according to functional elements and difficulty levels.

For example, a cluster 1 through a cluster 3 shown in FIG. 4 are those that are clustered to include the same functional elements but to be at difficulty levels classified according to high, medium, and low, or a certain ratio. The cluster 1 is clustered to include a project 1 and a project 3 that are classified to include a functional element 1, but to have a high difficulty level. The cluster 2 is clustered to include a project 2, a project 4, and a project 5 that are classified to include the functional element 1, but to have a medium difficulty level. A cluster 4 is clustered to include at least one project that includes a functional element 2 that is different from that of the cluster 1 through the cluster 3. Here, the first functional element 1, the functional element 2, and the like described in the above example are not limited to one functional element, but refer to a set of one or more functional elements.

As described above, according to an embodiment of the present disclosure, a plurality of first projects may be clustered on the basis of the same or different functional elements and difficulty levels.

In the case of the above example, for convenience of description, difficulty levels are divided into high, medium, and low. However, the division of difficulty levels is not limited thereto, and, as described above, may be configured at a certain ratio or a score corresponding thereto. In other words, when a difficulty level is divided into high, medium, and low, a possibility of an error occurring in clustering in the future is high. Therefore, a difficulty level based on a ratio or a score may be applied.

In another embodiment of the present disclosure, a plurality of first projects may be hierarchized and clustered on the basis of a functional element.

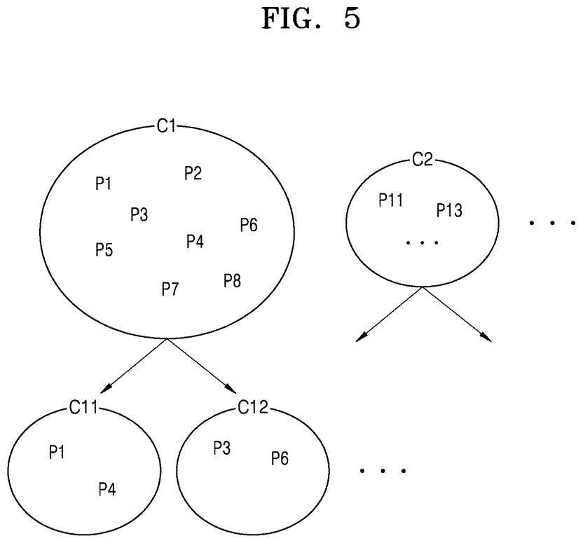

FIG. 5 is a view illustrating an example of primarily and secondarily clustering a plurality of first projects into a plurality of clusters.

In an embodiment, the server may perform clustering through a two-stage process.

The server may primarily cluster a plurality of first projects into a plurality of clusters, on the basis of the identity of functional elements of the plurality of first projects. In other words, the server may primarily cluster first projects having the same functional element.

As a result, as shown in FIG. 5, a project 1 through a project 8 including the same functional element 1 may be primarily clustered to be generated as one cluster 1, and projects including a functional element 2 different from the functional element 1 may be primarily clustered to be generated as one cluster 2.

The server may secondarily cluster, for each of the clusters according to the result of the primary clustering, a plurality of first projects belonging to each of the clusters into a plurality of clusters, on the basis of difficulty levels of the plurality of first projects. In other words, the server may classify, into a plurality of clusters, a cluster that is generated on the basis of the same functional element, according to difficulty levels.

As the result of the secondary clustering, the cluster 1 including the same functional element 1 is generated as a cluster 11 through a cluster 13 that are hierarchized according to difficulty levels. Here, the cluster 11 may be secondarily clustered to include the project 1 and the project 4 that are classified at the low difficulty level, and the cluster 12 may be secondarily clustered to include the project 3 and the project 6 that are classified at the medium difficulty level.

As described above, when primary clustering is performed according to the identity of functional elements, secondary clustering is performed on the basis of difficulty levels, upon later selection of a cluster for the application of a worker pool, a cluster including projects having the same functional elements and similar difficulty levels may be selected in detail.

Also, when functional elements are the same, but difficulty levels are not particularized, i.e., easy difficulty levels and difficult difficulty levels are evenly distributed within one project, and thus, the project is not classified at particular difficulty levels, a wide range of management may be provided, such as selecting only a primarily clustered cluster.

In addition, when functional elements are the same, but difficulty levels are not particularized, a primarily clustered cluster may be first selected. However, a plurality of tasks in a project may be classified according to difficulty levels, and secondarily clustered clusters may be respectively applied to the tasks that are classified according to the difficulty levels.

Referring to FIG. 3 again, in operation S120, the server templates and generates, for each of the clusters, a worker pool (hereinafter, referred to as a templated worker pool) including a plurality of workers 32 who participate in one or more first projects belonging to each of the clusters.

In other words, the server generates a plurality of workers 32 who participate in one or more first projects as a worker pool for one cluster, but may template and generate the worker pool.

Templating indicates that a worker pool is standardized for each cluster, and the standardized worker pool may be automatically applied when a similar project is determined in the future.

According to the result of such templating, a manager may easily allow the workers 32 to participate in a project by using a templated worker pool without setting certain participation conditions of the workers 32 to generate a worker pool of a particular project.

When a plurality of workers 32 who participate in a completed project are configured as a worker pool, a poor-quality worker may be pre-selected not to be included in a worker pool, as needed.

As described above, when clustering for a plurality of first projects is completed, in operation S125, the server identifies a functional element of a crowdsourcing-based project (hereinafter, referred to as a second project) scheduled to be opened.

Similarly, the functional element of the second project is determined on the basis of a work tool for performing the second project, and the work tool corresponds to a tool that is provided by the second project and used by the workers 32 to perform tasks requested by the second project.

In operation S130, the server evaluates a difficulty level of the second project by using a pilot task of the second project.

Here, according to an embodiment of the present disclosure, a difficulty level of a first project may be evaluated by using a work history thereof. However, a second project may be in a stage before a worker pool is determined, and thus, a difficulty level thereof may be evaluated by using a pilot task thereof.

Here, a pilot task is a task that is set to allow all workers 32 registered in a crowdsourcing platform to participate therein before the second project is officially opened, and is used to evaluate a difficulty level of the second project. Such a pilot task does not limit participation conditions of workers 32 until a worker pool is determined. However, according to an embodiment, for a more accurate evaluation of a difficulty level by excluding experienced workers, a pilot task may be provided for a first-time worker or a low-grade worker.

A certain ratio for determining the number of pilot tasks may be determined according to the reliability of the evaluation of a difficulty level. In other words, as the reliability of a difficulty level is high, the difficulty level may be accurately evaluated. Therefore, as the needed level of reliability is high, a corresponding ratio may be set to be lower.

In an embodiment, the server may evaluate difficulty levels of first and second projects, on the basis of at least one of a point in time of submission of work results of a certain percentage of all tasks of the projects, a rejection rate of initial work results, and a rejection rate of rework results.

In detail, a point in time of submission that is an evaluation element of a difficulty level may be expressed by numericalizing, as 1200/2400=0.5, a point in time corresponding to 1200 hours that is a point in time of submission of 500 cases that are 50% of all tasks when the entire schedule is 2400 hours and the total number of tasks is 1000 cases.

Such a point in time of submission has a lower figure as a difficulty level increases. In the case of a project having a high difficulty level, a point in time when 500 cases that are 50% of all tasks are submitted is 1200 hours. However, as the entire schedule increases, a calculated figure is even lower.

In the case of a second project, unlike a first project, since a work history thereof is not yet generated, a difficulty level needs to be determined for the entire schedule of pilot tasks by considering characteristics of the pilot tasks. Like the first project, a point in time of submission of work results of a certain percentage with respect to the entire schedule of the pilot tasks is numericalized and expressed. As such a figure is low, the second project may be evaluated as a high difficulty level.

According to an embodiment of the present disclosure, a point in time of submission of work results of a certain percentage of all tasks of a project may be calculated at a ratio of a previous point in time of submission or a subsequent point in time of submission with respect to the entire schedule of the project, or a percentage of tasks includes in a middle point in time of the project may be applied.

A rejection rate of an initial work result that is an evaluation element of a difficulty level refers to a rejection rate for an initial work result of the worker 32. Here, in an embodiment of the present disclosure, a rejection rate may be calculated for all tasks or all pilot tasks included in a project. However, a rejection rate may be calculated for the number of tasks at a particular point in time or at a certain percentage.

A rejection rate at a point in time when a certain percentage of all tasks is submitted, e.g., a rejection rate for initial work results, may be calculated as 20% when the number of cases that are rejected for initial work results from among 500 cases is 100 cases at a point in time when 500 cases that are 50% of all tasks are submitted.

Finally, a rejection rate for a rework result refers to a rejection rate for a rework result of the worker 32 after rejection according to an initial work result. In an embodiment of the present disclosure, in a similar way, a rejection rate may be calculated for all tasks or all pilot tasks included in a project, but a rejection rate may also be calculated for the number of tasks at a particular point in time or a certain percentage.

For example, at a point in time when 500 cases that are 50% of all tasks are submitted, when the number of cases having rejected initial work results is 100 cases from among 500 cases and the number of re-rejected cases is 20 cases from among same, a rejection rate of rework results may be calculated as 20%.

Here, in an embodiment of the present disclosure, the number of rejections due to rework may be accumulatively counted. In other words, when an initial rejection occurs for one task and two-time rejections occur for rework therefor, a rejection rate of the results of the rework may be counted for twice.

As described above, when difficulty level evaluation for a second project is completed, in operation S135, the server selects any one of a plurality of clusters and, in operation S140, applies a templated worker pool of the selected cluster as a worker pool of the second project, on the basis of a functional element and difficulty level of the second project.

As the worker pool is determined, in operation S145, the server opens the second project, assigns a plurality of tasks of the second project to a plurality of workers 32 of the worker pool to request the performance of the tasks and, in operation S150, receives a plurality of work results from the plurality of workers 32 of the worker pool.

As described above, in an embodiment of the present disclosure, completed projects may be clustered according to a certain criterion, and workers 32 who participate in a project included in the cluster may be templated and generated as a worker pool, thereby automatically apply a worker 32 matching characteristics of a new project to be opened by using the templated worker pool. Therefore, the time and cost taken for selecting the worker 32 by a client or a service provider company may be significantly reduced.

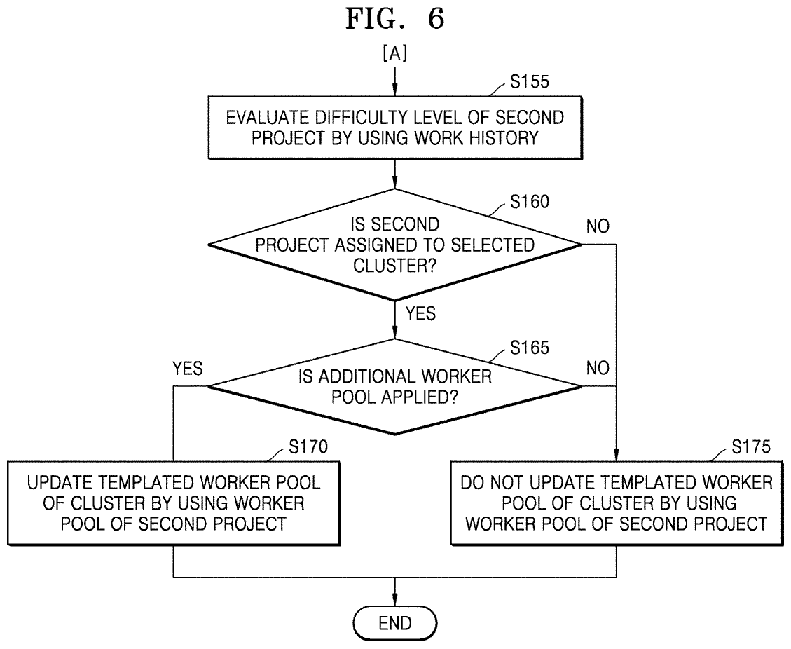

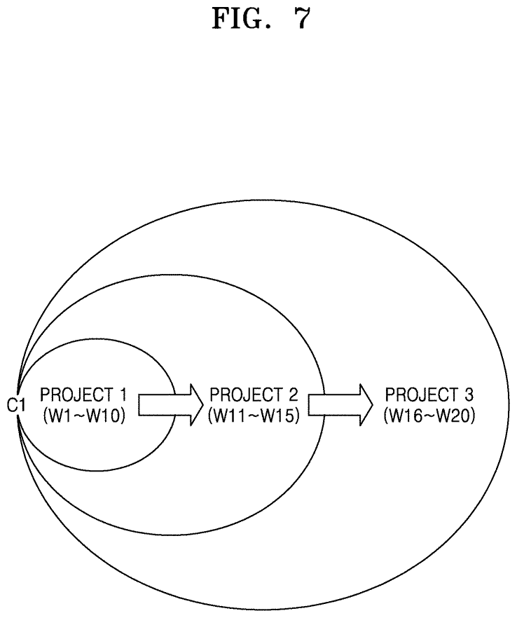

FIG. 6 is a flowchart illustrating a process of updating a templated worker pool of a cluster. FIG. 7 is a view illustrating the contents of updating a templated worker pool.

In an embodiment of the present disclosure, as a second project is completed, in operation S155, the server may evaluate a difficulty level of the second project by using a work history of the second project and, in operation S160, determine whether or not to assign the second project to a selected cluster, on the basis of a functional element and a difficulty level of the second project.

Here, the work history of the second project is recorded by using a plurality of inspection results. In other words, the server may assign a plurality of work results to a plurality of inspectors 34 to request the performance of inspection, and receive, from the plurality of inspectors 34, a plurality of inspection results for the plurality of work results as inspection passes or rejections, and, on the basis of the inspection results, the work history of the second project may be recorded.

Evaluating a difficulty level by using pilot tasks in the second project, which is a previous process, corresponds to prediction, and evaluating a difficulty level by using a work history is a process of identifying whether or not the prediction is correct.

Here, when the difficulty level evaluated through the pilot tasks of the second project and the difficulty level evaluated by using the work history match each other or meet a certain criterion range, the server may determine to assign the second project to the selected cluster.

When the second project is assigned to a cluster, a cluster of a project having a more accurately matching difficulty levels may be selected when a worker pool of another second project later.

In this process, when, in addition to the templated worker pool of the selected cluster, an additional worker pool is applied as the worker pool of the second project in operation S165-Y, and the server determines to assign the second project to the selected cluster, in operation S170, the server may update the templated worker pool of the selected cluster by using the worker pool of the second project.

For example, referring to FIG. 7, in a state where workers W1 through W10 (ten people) who participate in a project 1 are templated as a worker pool of a cluster 1, upon performance of a second project (a project 2), when, in addition to workers of the selected cluster 1, works W11 through W15 (five people) who do not participate in the project 1 additionally participate as workers of the second project, a worker pool of the second project is W1 through W15 (15 people).

When the second project is completed and the server determines to assign the second project to the cluster 1, in addition to an existing worker pool of W1 through W10, the server may add the workers W11 through W15 to an existing templated worker pool to update the existing templated worker pool.

Similarly, when another second project (a project 3) is completed and the project 3 is determined to be assigned to the cluster 1 by the server, additional workers 32 in the corresponding project may be added to the worker pool of the cluster 1 to update the worker pool of the cluster 1.

In contrast, when the difficulty level evaluated through the pilot tasks of the second project and the difficulty level evaluated by using the work history do not match each other or are out of the certain criterion range, in operation S160-N, the server determines not to assign the second project to the selected cluster. In this case, in operation S175, the server may not update the templated worker pool of the selected cluster by using the worker pool of the second project.

As prediction of a difficulty level via pilot tasks is wrong, the second project is performed by using an inappropriate worker pool. In this case, the server does not update the template worker pool of the selected cluster.

In an embodiment, although the second project is determined to be assigned to the selected cluster in operation S160-Y, when the additional worker pool is not applied in operation S165-N, the server does not update the templated worker pool of the selected cluster by using the worker pool of the second project in operation S175.

In an embodiment of the present disclosure, when an additional worker pool as described above is applied, through a process of determining whether or not to update the additional worker pool to a worker pool of a cluster, even though a difficulty level of a new second project to be opened gradually diversifies, a worker pool that more accurately matches the corresponding difficulty level may be applied.

In addition, detailed clustering on the basis of a difficulty level may be performed together to apply a worker pool that more matches a difficulty level of a new second project.

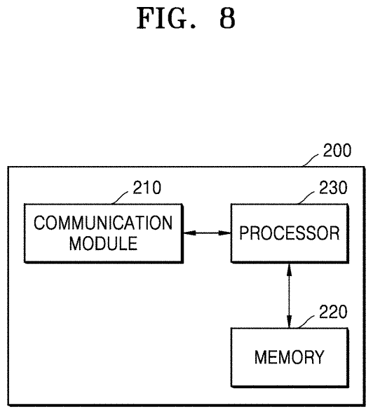

In the above description, according to an embodiment of the present disclosure, operations S110 through S175 may be further divided into additional operations or may be combined into sub-operations. Also, some operations may be omitted when needed or the order between operations may also be changed. In addition, even though the following description of FIG. 8 is omitted, the description may also be applied to a method of automatically generating a worker pool based on a functional element and a difficulty level of a crowdsourcing-based project described with reference to FIGS. 1 through 7.

Hereinafter, an apparatus 200 (hereinafter, referred to as a worker pool automatic generation apparatus) for automatically generating a worker pool based on a functional element and a difficulty level of a crowdsourcing-based project according to an embodiment of the present disclosure will be described.

FIG. 8 is a block diagram illustrating a worker pool automatic generation apparatus 200 according to an embodiment of the present disclosure.

Referring to FIG. 8, the worker pool automatic generation apparatus 200 includes a communication module 210, a memory 220, and a processor 230.

The communication module 210 transmits a plurality of crowdsourcing-based tasks of one project to a plurality of workers 32 of a worker pool to request the performance of the tasks, and receives work results from the plurality of workers 32 of the worker pool. Also, the communication module 210 transmits, to a plurality of inspectors 34, the plurality of work results received from the plurality of workers 32 to request inspection, and receives inspection results from the plurality of inspectors 34.

The memory 220 stores a program for automatically determining a worker pool for a new project scheduled to be opened, on the basis of functional elements and difficulty levels of projects.

The processor 230 executes the program stored in the memory 220. The processor 230 executes the program stored in the memory 220 to identify a functional element of a first project, evaluate difficulty levels of a plurality of first projects by using a work history of the first project, cluster the plurality of first projects into a plurality of clusters on the basis of the functional element and the difficulty level, and, for each of the clusters, and template and generate, for each of the clusters, a worker pool including a plurality of workers 32 who participate in one or more first projects belonging to each of the clusters.

The processor 230 identifies a functional element of a second project scheduled to be opened, evaluates a difficulty level of the second project by using pilot tasks of the second project, selects any one of a plurality of clusters on the basis of the functional element and the difficulty level, and applies a templated worker pool of the corresponding cluster as a worker pool of the second project.

A method of automatically generating a worker pool based on a functional element and a difficulty level of a crowdsourcing-based project according to an embodiment of the present disclosure, as described above, may be implemented as a program (or an application) and stored in a medium to be combined with a computer that is hardware to be executed.

In order for the computer to read the program and execute the methods implemented as the program, the above-described program may include a code written in a computer language such as C, C++, JAVA, Ruby, and machine language that may be read by a processor (CPU) of the computer via a device interface of the computer. Such code may include functional code related to a function that defines functions needed for executing the above methods and the like, and may include execution procedure-related control code needed for the processor of the computer to execute the functions according to a preset procedure. Also, such code may further include memory reference-related code indicating a location (address) in an internal or external memory of the computer at which additional information or media needed for the processor of the computer to execute the functions may be referred to. Also, when the processor of the computer needs to communicate with any other computer or server at a remote location to execute the functions, the code may further include communication-related code indicating a method of communicating with any other computer or server at a remote location by using a communication module of the computer, and information or media that is transmitted and/or received during communication and the like.

The storage medium refers to a medium that stores data semi-permanently and may be read by a device, rather than a medium that stores data for a short moment, such as a register, a cache, or a memory. In detail, examples of the storage medium include ROM, RAM, CD-ROMs, magnetic tape, floppy disks, optical data storage devices, and the like but are not limited thereto. In other words, the program may be stored in various types of recording media on various servers that may be accessed by the computer or in various types of recording media on the computer of a user. Also, the media may be distributed over network-coupled computer systems so that computer-readable code is stored in a distributed fashion.

The foregoing description of the disclosure is for purposes of illustration, and those of ordinary skill in the art to which the disclosure pertains may understand that it may be easily modified into other specific forms without changing the technical spirit or essential features of the disclosure. Therefore, it may be understood that the embodiments described above are illustrative in all respects and not restrictive. For example, each element described as a single type may be implemented in a distributed manner, and likewise, elements described as being distributed may also be implemented in a combined form.

The scope of the disclosure is defined by the following claims, rather than by the above description, and all changes or modifications derived from the concept and scope of the claims and equivalents thereof may be construed as being included in the scope of the disclosure.

1. A method of automatically generating a worker pool based on a functional element and a difficulty level of a crowdsourcing-based project, performed by a computer, the method comprising:
identifying functional elements of a plurality of completed crowdsourcing-based projects (hereinafter, first projects);
evaluating difficulty levels of the plurality of first projects by using work histories of the plurality of first projects;
clustering the plurality of first projects into a plurality of clusters, on the basis of the functional elements and the difficulty levels of the plurality of first projects;
templating and generating, for each of the clusters, a worker pool (hereinafter, a templated worker pool) including a plurality of workers who participate in one or more first projects belonging to each of the clusters;
identifying a functional element of a crowdsourcing-based project (hereinafter, a second project) scheduled to be opened;
evaluating a predicted difficulty level of the second project by using pilot tasks of the second project;
selecting any one of the plurality of clusters, on the basis of the functional element and the predicted difficulty level of the second project;
applying the templated worker pool of the selected cluster as a worker pool of the second project;
opening the second project and assigning a plurality of tasks of the second project to a plurality of workers of the templated worker pool to request performance of the tasks; and
receiving a plurality of work results from the plurality of workers of the templated worker pool, wherein
the functional element is determined on the basis of a work tool for performing a project,
the work tool is a tool provided by the project and used by workers to perform tasks requested by the project,
the method further includes: after the second project is completed, evaluating an actual difficulty level of the second project by using a work history of the second project; and
determining whether or not to assign the second project to the selected cluster by comparing the predicted difficulty level of the second project with the actual difficulty level,
the method further includes, when an additional worker pool is applied as the worker pool of the second project in addition to the templated worker pool of the selected cluster, and the second project is determined to be assigned to the selected cluster, updating the templated worker pool of the selected cluster by using the worker pool of the second project, and,
the method further includes, when the second project is determined not to be assigned to the selected cluster, not updating the templated worker pool of the selected cluster by using the worker pool of the second project.

2. The method of claim 1, wherein the difficulty level is evaluated on the basis of at least one of a point in time of submission of work results of a certain percentage of all tasks of a project, a rejection rate of initial work results, and a rejection rate of rework results.

3. The method of claim 1, wherein
the clustering the plurality of first projects into the plurality of clusters on the basis of the functional elements and the difficulty levels of the plurality of first projects includes:
primarily clustering the plurality of first projects into a plurality of clusters, on the basis of identity of the functional elements of the plurality of first projects; and
secondarily clustering, for each of the clusters according to the result of the primary clustering, a plurality of first projects belonging to each of the clusters into a plurality of clusters, on the basis of the difficulty levels of the plurality of first projects.

4. The method of claim 1, wherein the evaluating the predicted difficulty level of the second project by using the pilot tasks includes using a certain percentage of all tasks of the second project as the pilot tasks.

5. The method of claim 4, wherein the percentage is determined according to reliability of the evaluation of the predicted difficulty level.

6. The method of claim 1, further comprising:
assigning the plurality of work results to a plurality of inspectors to request performance of inspection; and
receiving, from the plurality of inspectors, a plurality of inspection results for the plurality of work results as inspection passes or rejections, wherein
the work history of the second project is recorded by using the plurality of inspection results.

7. A non-transitory computer program stored in a computer-readable recording medium to be combined with a computer to execute the method of claim 1 of automatically generating a worker pool based on a functional element and a difficulty level of a crowdsourcing-based project.
